(19) United States
(12) Patent Application Publication
(10) Pub. No.: US 2025/0278010 A1
(43) Pub. Date: Sep. 4, 2025

(54) OPTICAL WAVEGUIDE ARRAY DEVICE AND METHOD FOR OPERATING THEREOF

(71) Applicant: Ian Clague, Bristol (GB)

(72) Inventor: Ian Clague, Bristol (GB)

(21) Appl. No.: 18/658,514

(22) Filed: May 8, 2024

(30) Foreign Application Priority Data
Mar. 4, 2024 (GB) 2403091.8

(51) Int. Cl. G02F 1/365; G02F 1/35; G02F 1/355

(52) U.S. Cl. CPC G02F 1/365; G02F 1/3505; G02F 1/3507; G02F 1/3513; G02F 1/355

(57) ABSTRACT

There is provided an optical waveguide array device including a substrate, and at least one waveguide structure formed onto the substrate, wherein the at least one waveguide structure is fabricated at least in part from a material that exhibits one or more non-linear optical effects when in use, and an electrode arrangement configured to control the one or more non-linear optical effects and to extract at least one of accelerated electrons and positrons from the at least one waveguide structure. The optical waveguide array device is configured in use to separate photons input on the at least one waveguide structure using the one or more non-linear optical effects into their respective electrons and positrons, and to guide the respective electrons and positrons into their respective regions of the at least one waveguide structure to cause a matter-antimatter dipole to be formed within the at least one waveguide structure waveguide structure for imparting energy to at least one of the electrons and the positrons to cause acceleration thereof.

### TECHNICAL FIELD

The present disclosure relates to optical waveguide array devices. Moreover, the present disclosure relates to methods for operating aforesaid optical waveguide array devices. Beneficially, the optical waveguide array devices of the present disclosure are configured to use a non-linear photo-electric effect, for example a Kerr effect, to separate photons into their corresponding electrons and photons. Moreover, the present disclosure also relates to optical waveguide arrays, for example for use in the aforesaid optical waveguide array devices.

### BACKGROUND

In modern physics, there occur “ordinary matter” and corresponding antimatter. Antimatter may be conventionally thought of as being matter with reversed charge, parity and time, known as CPT reversal. Antimatter occurs in natural processes, for example in cosmic ray collisions occurring in the Earth's upper atmosphere and also as a component generated during radioactive decay, for example radioactive decay giving rise to beta particles. On Earth, antimatter tends to annihilate with ordinary matter to generate corresponding electromagnetic radiation, for example photons. However, it is known to store antimatter under vacuum conditions in at least one of strong electrostatic fields and magnetic fields for periods of up to circa 1000 hours. For example, the ALPHA project at CERN is concerned with generating positrons for research purposes, wherein the ALPHA project makes use of a high-energy particle accelerator to generate high-energy ordinary matter particles at an energy of GeV that are applied to a high atomic weight (“high-Z”) target to generate a range of secondary particles, wherein a portion of the secondary particles are positrons at high energy; a decelerator is used to decelerate the high energy positrons to provide corresponding lower-energy positrons, and a vacuum storage ring arrangement is used to store the lower-energy positrons for use in various experiments and research, for example anti-gravity research.

As described in a published PCT patent application PCT/IB2022/057745 (“System and method for generating power”, inventor Ian Clague), it is shown that a given photon may be considered to be a composite particle comprising an electron and a positron orbiting around each other; as the electron has a positive mass and the positron has a negative mass, their corresponding photon has zero mass, enabling the photon to propagate at “the speed c of light”, namely 299,792,458 metres per second, in vacuum. An energy of the photon (namely E=hf wherein h is Plank's constant, E is the energy of the photon and f is the frequency of the photon) is determined by parameters of a precession orbit of the electron and its corresponding positron in the photon; for example, lower energy infra-red photons have a larger precession orbit and therefore a longer corresponding wavelength than, example, a gamma ray photon. Such orbits are, for example, manifest in interference fringes generated using photons, for example in diffraction gratings.

In a publication “Coherent propulsion with negative-mass fields in a photon lattice”, Yumiao Pei, et al., Vol. 44 No. 24, December 2019, Optics Letters, there is described a theoretical basis for coherent propulsion with negative-mass fields in an optical analog, wherein there are observed self-accelerating states, driven by non-linear coherent interactions of two components that are experiencing diffractions of opposite signs in a photonic lattice; such a situation is analogous to an interaction of two objects with mutually opposite mass signs. In the publication, there is described an experimental setup including a continuous wave (CW) green laser emitting electromagnetic radiation at a wavelength of 532 nm. There is further used a waveguide array having a lattice period of 6.8 μm which is fabricated by Titanium in-diffusion in a non-linear photorefractive Lithium Niobate (LINbO₃) crystal that, in use, exhibits a self-defocusing non-linearity arising from a bulk photovoltaic effect. There arise positive-mass and negative-mass fields in the crystal. In overview, the positive-mass and negative-mass fields are able to affect photons propagating in the crystal to cause electron beams and positron beams to form within the crystal, wherein the beams propagate because they are still described by a coherent wavefunction pursuant to the Schrödinger equation.

There therefrom arises an action-reaction symmetry that breaks Newton's third law, wherein the symmetry abides to both energy and momentum conservation. When spatial separation of electrons and positrons occurs in the crystal, acceleration effects between the electrons and positrons are observed. The publication in Optics Letters has been peer-reviewed and is to be now regarded as accepted main-stream scientific knowledge.

In a further scientific publication “Self-accelerating beams of photons and electrons” by author Ady Arie, Tel Aviv, Israel, CLEO: 2014, there are disclosed properties of optical, electron and plasmon beams that preserve their shape, while propagating along curved trajectories in free-space or propagating on a surface. When such surface propagation occurs, there arise surface-plasmon-polaritons that are surface electromagnetic waves that occur at an interface between a metal and dielectric medium and are coupled to collective electron oscillations in the metal.

Despite aforesaid insight into interactions between optical beams and crystal substrates have been published, there has been a lack of commercial use of the effects to provide practical devices for positron generation, as well as providing energy conversion apparatus. The present disclosure seeks to address the lack. It is to be appreciated that none of the embodiments of the present disclosure described below are in violation of known laws of physics; moreover, it is to be appreciated that classic Newtonian laws must be interpreted appropriately in view of recent contemporary scientific research, for example as elucidated in the foregoing publications.

### SUMMARY

The present disclosure seeks to provide a practical optical waveguide array device that is configured to function to convert photons to corresponding positrons and electrons in a more efficient and convenient manner than has hitherto been feasible. Moreover, the present disclosure seeks to provide an improved method for (namely, method of) operating the aforesaid optical waveguide array device.

According to a first aspect, there is provided an optical waveguide array device as defined in the appended claim 1. The optical waveguide array device is of advantage in that the array device is designed to spatially separate electrons and positrons from incident photons in a more efficient and controllable manner.

There is provided an optical waveguide array device including a substrate, and at least one waveguide structure formed onto the substrate, wherein the at least one waveguide structure is fabricated at least in part from a material that exhibits one or more non-linear optical effects when in use, and an electrode arrangement configured to control the one or more non-linear optical effects and to extract at least one of accelerated electrons and positrons from the at least one waveguide structure, and wherein the optical waveguide array device is configured when in use to separate photons input on the at least one waveguide structure using the one or more non-linear optical effects into their respective electrons and positrons, and to guide the respective electrons and positrons into their respective regions of the at least one waveguide structure to cause a matter-antimatter dipole to be formed within the at least one waveguide structure waveguide structure for imparting energy to at least one of the electrons and positrons to cause acceleration thereof.

Beneficially, the one or more non-linear optical effects includes an optical Kerr effect. The optical Kerr effect results in a refractive index change that causes the substrate electrons to group with other electrons, and likewise substrate positrons to group with other positrons, resulting in an enhanced positron-electron dipole, and thereby enhanced acceleration experienced by the electrons and the positrons within the array device.

Optionally, in the optical waveguide array device, the substrate is fabricated from a dielectric material, and the material of the at least one waveguide structure includes at least one of: Lithium Niobate (LiNiO₃), Barium Niobate (BaNiO₃), Graphene, doped Graphene.

Optionally, in the optical waveguide array device, the substrate is fabricated from a dielectric material; optionally, the dielectric material includes at least one of: quartz, fused silica. Other dielectric materials may be used, for example sapphire, Silicon Nitrate and so forth.

Optionally, in the optical waveguide array device, the electrode arrangement comprises a configuration of electrodes whose elongate axes are configured to be substantially parallel to, or substantially orthogonal to, elongate axes of a plurality elongate waveguides into which the corresponding electrons and positrons are selectively diverted when the device is in operation. More optionally, in the optical waveguide array device, the electrode arrangement is fabricated from at least one of: Titanium, Aluminium, Indium, Silver. Other metals may optionally be used.

Optionally, in the optical waveguide array device, the device includes a plurality of the at least one waveguide structure arranged in a cascaded configuration.

Optionally, in the optical waveguide array device, there is further included a laser arrangement configured in use to provide photons to the at least one waveguide structure. More optionally, in the optical waveguide array device, the laser arrangement is configured to function in at least one of: a continuous mode, a pulsed mode, a combination of continuous and pulsed modes.

Optionally, in the optical waveguide array device, waveguides of the at least one waveguide structure are disposed in a parallel mutually-spaced-apart manner with a distance (d) therebetween, wherein the distance (d) is substantially of a similar size to a wavelength of the photons supplied to the at least one waveguide structure when in operation. More optionally, in the optical waveguide array device, the distance (d) is configured to allow for photon coherence to be maintained between mutually adjacent elongate waveguides of the at least one waveguide structure.

According to a second aspect, there is provided a method as claimed in independent claim 10.

There is provided a method for (namely, a method of) operating an optical waveguide array device including a substrate, and at least one waveguide structure formed onto the substrate, wherein the method includes:
(i) arranging for the at least one waveguide structure to be fabricated at least in part from a material that exhibits one or more non-linear optical effects when in use;
(ii) configuring an electrode arrangement to control the one or more non-linear optical effects and to extract at least one of accelerated electrons and positrons from the at least one waveguide structure;
(iii) configuring the optical waveguide array device, when in use, to separate photons input on the at least one waveguide structure using the one or more non-linear optical effects into their respective electrons and positrons; and
(iv) guiding the respective electrons and positrons into their respective regions of the at least one waveguide structure to cause a matter-antimatter dipole to be formed within the at least one waveguide structure waveguide structure for imparting energy to at least one of the electrons and positrons to cause acceleration thereof.

Beneficially, the one or more non-linear optical effects includes an optical Kerr effect. The optical Kerr effect results in a refractive index change that causes the substrate electrons to group with other electrons, and likewise substrate positrons to group with other positrons, resulting in an enhanced positron-electron dipole, and thereby enhanced acceleration experienced by the electrons and the positrons within the array device.

Optionally, the method includes fabricating the substrate from a dielectric material, and arranging for the material of the at least one waveguide structure to include at least one of: Lithium Niobate (LiNiO₃), Barium Niobate (BaNiO₃), Graphene, doped Graphene.

Optionally, the method includes fabricating the substrate from at least one of: quartz, fused silica. Other dielectric materials may optionally be used for the substrate.

Optionally, the method includes arranging for the electrode arrangement to comprise a configuration of electrodes whose elongate axes are configured to be substantially parallel to, or substantially orthogonal to, elongate axes of a plurality elongate waveguides into which the corresponding electrons and positrons are selectively diverted when the device is in operation. More optionally, the method includes arranging for the electrode arrangement to be fabricated from at least one of: Titanium, Aluminium, Indium, Silver. Other metals may optionally be used, even doped semiconductor materials.

Optionally, the method includes arranging for the device to include a plurality of the at least one waveguide structure arranged in a cascaded configuration.

Optionally, the method further includes arranging for the device to further include a laser arrangement configured in use to provide photons to the at least one waveguide structure. More optionally, the method includes configuring the laser arrangement to function in at least one of: a continuous mode, a pulsed mode, a combination of continuous and pulsed modes.

Optionally, the method includes arranging for waveguides of the at least one waveguide structure to be disposed in a substantially parallel and mutually-spaced-apart manner with a distance (d) therebetween, wherein the distance (d) is substantially of a similar size to a wavelength of the photons supplied to the at least one waveguide structure when in operation; for example, the photons have a wavelength in a range of 50 nm to 3 μm, more optionally substantially 1500 nm. More optionally, the method includes configuring the distance (d) to allow for photon coherence to be maintained between mutually adjacent elongate waveguides of the at least one waveguide structure.

According to a third aspect, there is provided a software product as claimed in independent claim 18. There is provided a software product recorded on a machine-readable data carrier, wherein the software product is executable on computing hardware of the device of the first aspect, to implement a method of the second aspect.

### DESCRIPTION OF DIAGRAMS

Embodiments of the invention will be described with reference to the following drawings, wherein:

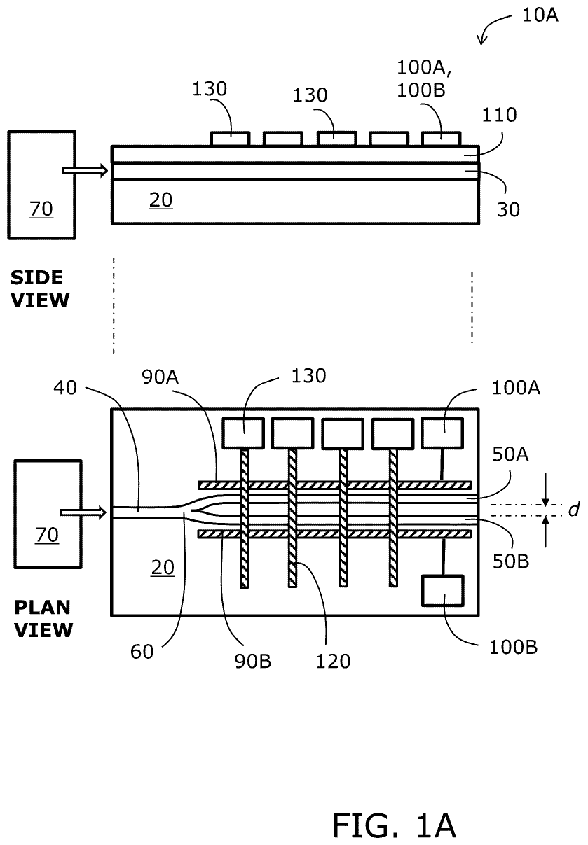

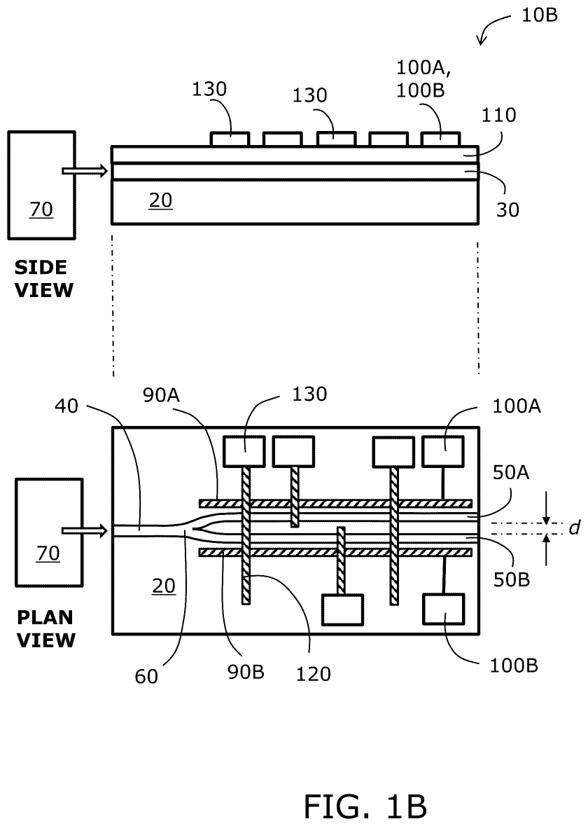

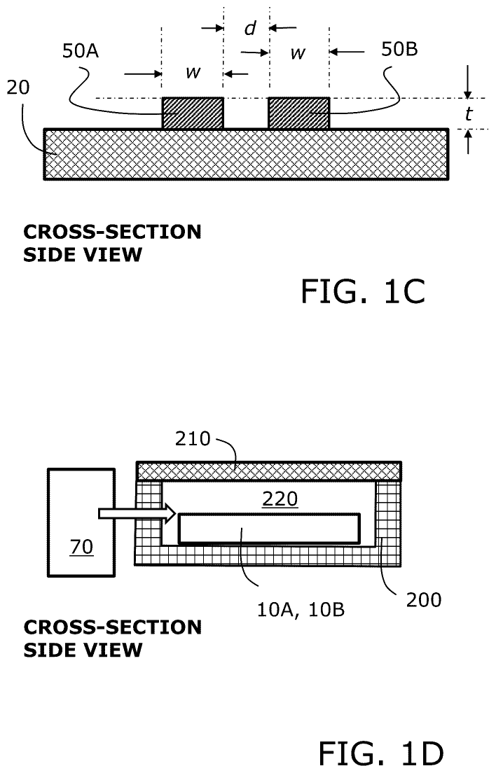

FIGS. 1A and 1B are schematic illustrations of simple implementations of an optical waveguide array according to the present disclosure;

FIG. 1C is a schematical illustration of a cross-section of a waveguide structure used in the implementations of FIGS. 1A and 1B; FIG. 1D is a schematic illustration of the optical waveguide array mounted within a ceramic module package;

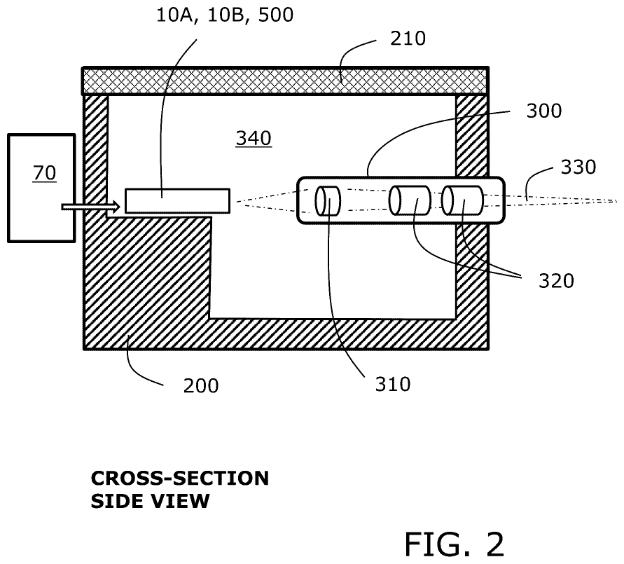

FIG. 2 is a schematic illustration of the optical waveguide array of FIGS. 1A, 1B, 1C and 1D configured to include a positron extraction arrangement to generate, when in use, a positron beam;

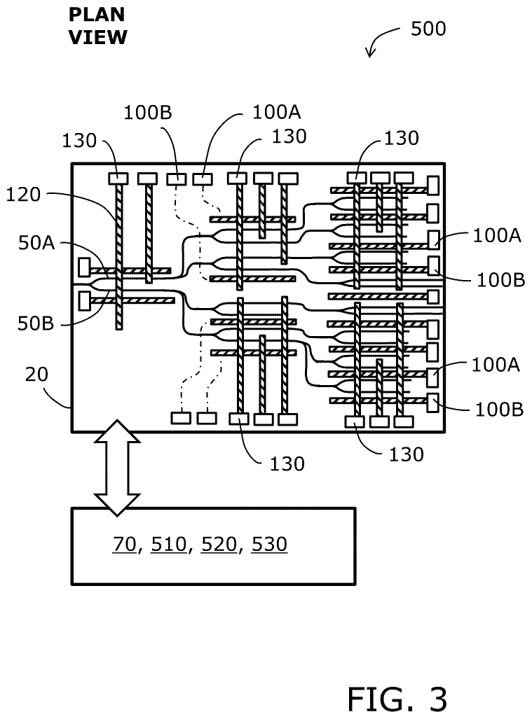

FIG. 3 is a schematic illustration of an optical waveguide array apparatus, including a plurality of the optical waveguide arrays of FIGS. 1A, 1B, 1C, 1D and 2 arranged in a cascaded configuration; and

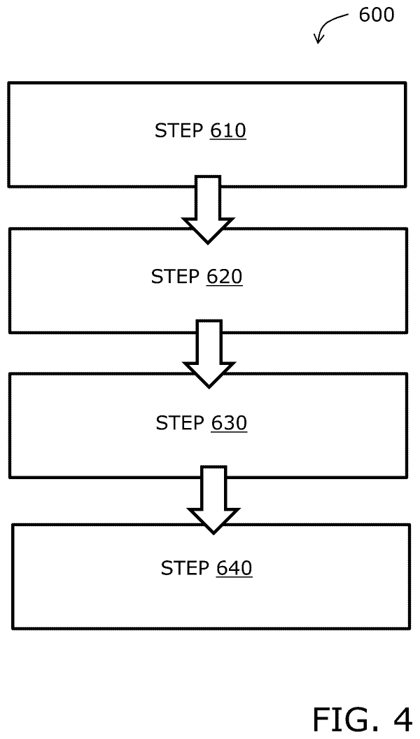

FIG. 4 is a flow chart depicting steps of a method for operating the optical waveguide array and optical waveguide apparatus of any one of FIGS. 1A, 1B, 1C, 1D, 2 and 3.

### DESCRIPTION OF EMBODIMENTS

In developing the optical waveguide array and also the optical waveguide device of the present disclosure, the technical problems associated with using aforesaid radioactive sources undergoing beta decay was very much borne in mind; these problems are addressed by the present disclosure. Moreover, the impracticality of using large particle accelerators and high-Z targets as aforementioned, to yield relatively small quantities of positrons, was also borne on mind. It was appreciated that a relatively compact and safe apparatus for generating copious quantities of positrons is required by industry and research establishments. Moreover, it was also appreciated that an alternative device for converting photons to electrical energy is required by industry and research establishments; the alternative device is conveniently referred to as being an “energy chip”.

Referring to FIG. 1A, there is shown a simple example of an optical waveguide array of the present disclosure, wherein the array is indicated generally by 10A. The array 10A is fabricated on a dielectric substrate 20, for example a fused silica substrate or a quartz substrate, on which is grown, for example via vapour-phase deposition, a layer of material 30, for example Lithium Niobate (LiNiO₃), Barium Niobate (BaNiO₃), Graphene, doped Graphene, which is configured to exhibit optical non-linearity, for example the optical Kerr effect as will be described in more detail later. Optionally, the layer of material 30 has a thickness (t) in a range of 30 nm to 2.0 μm, namely substantially similar to a wavelength of photons to be propagating along a waveguide structure that is formed by lithographic and etching processes into the layer of material 30. The waveguide structure includes an input waveguide 40 and two complementary waveguides 50A, 50B that branch laterally outwards from the input waveguide 40; the waveguides 50A, 50B beneficially have a length in a range of 30 μm to 10 mm, more optionally, the length is in a range of 50 μm to 1 mm, wherein the length determines an efficiency of the array 10, when in use, to create a matter-antimatter dipole within the array 10A, as will be described in greater detail later. A curved interfacing region 60 of the waveguide structure included between the input waveguide 40 and the two complementary waveguides 50A, 50B beneficially ensures an improved optical matching, to reduce photon reflection back towards a laser arrangement 70 that is used to provide photons to the array 10A. The layer of material 30 is lithographically formed, as aforementioned, for example by using e-beam or photoresists exposed during a lithographic operation, and by using a dry-etching process, for example reactive lative ion etching; such lithographic forming provides the input waveguide 40 and the complementary waveguides 50A, 50B, as well as the curved interfacing region 60. A distance (d) between the complementary waveguides 50A, 50B is beneficially in a range of 30 nm to 3.0 μm; for example, when the laser arrangement 70 is configured to provide photons having a wavelength in range of 100 nm to 2000 nm, for example substantially 1500 nm wavelength, the complementary waveguides 50A, 50B may have a width (w) in a range of 100 nm to 2 μm, for example a width of circa 1000 nm, wherein the distance (d) therebetween is optionally arranged to be substantially 400 nm to 450 nm. It will be appreciated that such dimensions may be varied when designing the array 10A, for example depending the wavelength of the photons provided from the laser arrangement 70. The laser arrangement 70 may be a continuous-wave mode laser for configuring the array 10A to function in a temporally continuous manner; alternatively, the laser arrangement 70 may be a pulsed mode laser for configuring the array 10 to function in a pulsed manner; yet alternatively, when in operation, the laser arrangement 70 is temporally switchable between operating in a continuous mode and a pulsed mode, wherein operation of the array 10A is varied accordingly.

Two elongate metallic electrodes 90A, 90B are provided as illustrated that are disposed with elongate axes substantially parallel to elongate axes of the waveguides 50A, 50B, wherein the metallic electrodes 90A, 90B are coupled to corresponding electrical wire bonding pads 100A, 100B, to which wire bonding may be performed, for making external electrical connections. The metallic electrodes 90A, 90B are beneficially optionally fabricated from Titanium, Aluminium, Indium, Silver or similar metal. Optionally, there are provided multiple electrodes 90 on each outside side of waveguides 50A, 50B, wherein the multiple electrodes 90 are configured both to provide bias electric fields to the waveguides 50A, 50B and also to extract electrons from the waveguides 50A, 50B. Such bias electric fields may be arranged in use to induce non-linear optical effects in the waveguides 50A, 50B, for example to induce various types of optical Kerr effect that will be described in greater detail below.

Optionally, a further dielectric layer, for example silica (SiO₂) (namely Silicon Dioxide) Silicon Nitride or a polymeric material), 110 is formed onto the layer 30, and also directly onto the substrate 20 in regions where the layer 30 has been removed from the substrate 20 by etching. A conductive layer of metal, for example Titanium, Aluminium, Indium, Silver or similar metal, is deposited during fabrication onto an exterior surface of the layer 110, wherein the conductive layer of metal is then lithographically patterned and then etched to provide one or more elongate electrodes 120 whose one or more corresponding elongate axes are substantially orthogonal to the elongate axes of the waveguides 50A, 50B. The one or more elongate electrodes 120 are terminated at corresponding wire bonding pads 130. The layer 110 serves to isolate the one or more electrodes 120 electrically from the multiple electrodes 90. In FIG. 1A, the one or more electrodes 120 are shown to be overlaying both of the waveguides 50A, 50B.

In FIG. 1B, there is shown an illustration of an optical waveguide array indicated generally by 10B. The waveguide array 10B differs from the aforesaid waveguide array 10A, in that at least one of the one or more electrodes 120 selectively overlay only one of the waveguides 50A, 50B for selectively modifying a wavefunction of photons that coherently includes both of the waveguide 50A, 50B to provide more effective segregation of electrons and positrons in the optical waveguide array 10B, when in operation.

As shown in FIG. 1D, the array 10A, 10B is then beneficially mounted to a ceramic module package 200 that is hermetically sealed using a lid 210, for example with a region filled inert Argon gas atmosphere or vacuum 220 therein; wire bonding is beneficially used to connect the aforesaid wire bonding pads 100, 130 to connection pins of the ceramic module package 200. Optionally, the laser arrangement 70 is also housed within the same ceramic module package 200 as the array 10A, 10B. Alternatively, the laser arrangement 70 may be housed remotely from the array 10A, 10B and its associated ceramic module package 200, for example with photons generated in use by the laser arrangement 70 being coupled via an optical fibre link (not shown) to the array 10A, 10B.

Optionally, the ceramic module package 200 is operated with a vacuum provided therein, as aforementioned. As shown in FIG. 2, the ceramic module package 200 is modified in shape, and is further provided with an electrode arrangement 300 spaced apart from the substrate 20 to collect or guide positrons ejected from one or more end of the waveguides 50A, 50B, to form a positron beam 330; optionally, an edge of the substrate 20 extends beyond a mounting ledge of the ceramic module package 200, as shown in FIG. 2, to allow an intense electric field to be applied in use at the edge of the substrate 20, in particular to ends of the waveguides 50A, 50B that extend to a peripheral edge of the substrate 20. The electrode arrangement 300 beneficial includes an extraction electrode 310 disposed nearest to the array 10A, 10B, and one or more focusing electrodes 320 disposed more remotely from the array 10A, 10B; the electrodes 310, 320 are optionally rotationally symmetrical, namely of a ring-like or cylindrical-like form. Within the ceramic module package 200, an internal volume is beneficially maintained as a vacuum, for example in a range of 10⁻⁷ to 10⁻¹¹ mBar, to avoid annihilation of positrons extracted from the array 10A, 10B; optionally, the ceramic module package 200 is provided with a “getter” therein, as historically used in thermionic vacuum tubes (for example ECC83 or EL34 types) to help to maintain such a high vacuum. Such an arrangement allows for the array 10A, 10B to be used as a positron source for performing positron tomography as well as being used for antimatter research, or even energy storage. However, it will be appreciated that accelerated electrons are beneficially coupled to the elongate electrodes 90 and then extracted from the ceramic module package 200, both for configurations as depicted in FIGS. 1A, 1D, 1C and 1D, and FIG. 2. Such a manner of operation enables the array 10A, 10B to be used as an energy converter, namely converting photon energy into electrical energy. In an optional configuration, at least a part of the converted electrical energy is provided back to the laser arrangement 70 for reuse to generate photons. The arrangement depicted in FIG. 2 may also be used with a device 500 of FIG. 3, as will be described below.

The array 10A, 10B beneficially functions by using the optical Kerr effect, also known as a quadratic electro-optical (QEO) effect. The effect is known to cause positron focusing, for example, as reported in various scientific publications. The Kerr effect is a change in the refractive index of a material in response to an electric field being applied to the material. The Kerr effect is distinct from the Pockels effect in that the induced refractive index change is directly proportional to the square of the applied electric field instead of varying linearly therewith.

There are two special cases of the Kerr effect: (i) DC Kerr effect (electro-optic effect); and (ii) AC Kerr effect (optical Kerr effect). The AC Kerr effect arises when the electric field is due to light itself, causing a refractive index variation that is responsible for non-linear optical effects of self-focusing, self-phase modulation and modulational instability. This AC Kerr effect becomes especially significant when the array 10A, 10B is used in a pulse mode, namely when the laser arrangement 70 is operated in a pulse mode.

In operation, photons are generated by the laser arrangement 70 that propagate to the substrate 20 and are injected into the input waveguide 40. The photons propagate along the input waveguide 40 to the curved interfacing region 60 which is spatially progressively influenced by the Kerr effect resulting from one or more of the electrodes 90, 120 being biased by applying bias voltages thereto. The Kerr effect results in more electrons of the photons being diverted to a given elongate waveguide 50, for example the waveguide 50A, relative the other elongate waveguide 50, for example the waveguide 50B. On account of the elongate waveguides 50A, 50B mutually spatially close together, a (Schrödinger) equation wavefunction describing the photons remains coherent and excess positrons generated in one of the two waveguide 50 do not annihilate with positive matter forming the waveguide 50. In FIG. 2, when such positrons are extracted from the one of the waveguides 50, for example by biasing the positron extraction arrangement 300 of extraction electrodes to be negatively biased relative to the substrate 20 and its associated electrodes 90, 120, the positrons enter vacuum and their corresponding photon wavefunctions then collapse into decoherence in the elongate waveguides 50A, 50B. The positron extraction arrangement 300 of is beneficially implemented using aforesaid at least one of annular and cylindrical electrodes 310, 320, that are coupled in use to an electrical potential biasing arrangement (not shown), wherein the electrodes 310, 320 are suitably biased in use for extracting the positrons from one or more of the waveguides 50A, 50B supported on the substrate 20, and forming them into the positron beam 330. The positron beam 330 may be used in positron tomography, in energy storage, in propulsion systems or in research, for example.

For conserving energy when operating the array 10A, 10B, both the laser arrangement 70 and bias voltages applied to at least a subset of the electrodes 90, 120 may be applied as a series of temporal pulses; beneficially, the applied temporal pulses are mutually synchronized, for example with a phase delay included therebetween to cope with propagation delays of photons between the laser arrangement 70 and the array 10A, 10B

It will be appreciated that an excess of electrons in one of the elongate waveguides 50, for example the waveguide 50A, and an excess of positrons in another of the elongate waveguides 50, for example the waveguide 50B, causes a matter-antimatter dipole to be formed within the array 10A, 10B that is effective to accelerate the electrons relative to the positrons. The electrodes 120 may optionally be used to spatially confine the positrons whilst their corresponding electrons are accelerated along their waveguide 50 and coupled to their responding spatially closely-disposed elongate electrode 90. Alternatively, the electrodes 120 may optionally be used to spatially confine the electrons whilst their corresponding positrons are accelerated along their waveguide 50 and extracted to form the positron beam 330. In operation, the electrons appear to gain energy from interacting with the positrons, which is manifested as a significant voltage being output from the elongate electrode 90, for example, in an order of several eV at least.

Referring next to FIG. 3, in order to achieve a greater performance, a plurality of the arrays 10A, 10B as depicted in FIGS. 1A and 1B may be disposed on the substrate 20 in a spatially cascaded configuration, as illustrated in FIG. 3. Such a cascaded configuration enables multiple matter-antimatter dipoles to be formed of progressively greater magnitude that contributes to an improved efficiency of operation of the substrate 20 and its associated components. As a result, a yield of at least one of accelerated electrons and positrons generated from the substrate 20 may be considerably enhanced.

In FIG. 3, there is shown a waveguide arrangement apparatus indicated generally by 500, wherein ends of waveguides 50A, 50B of a given array 10A, 10B are routed to corresponding input waveguides 40 of a subsequent array 10A, 10B as illustrated; the arrays 10A, 10B are mutually fabricated together on the substrate 20. There are beneficially at least two cascaded arrays 10A, 10B in a given series in the waveguide arrangement apparatus 500. The number of cascaded arrays 10A, 10B is determined by coherence of photons that may be achieved in use. In FIG. 3, each array 10A, 10B is provided with its corresponding electrodes 90, 120, wherein the electrodes 90, 120 are routed via a signal processing arrangement 510 to a control arrangement 520 implemented using at least one of a RISC processor, a field-programmable gate array (FPGA) or similar. The control arrangement 520 is configured to execute one or more software products stored on a data storage medium to control operation. The signal processing 530 is configured to provide an output signal, for example an output voltage of appreciable power.

The waveguide arrangement apparatus 500 may be configured as an energy generating device, for example when photons for the waveguide structure are provided from an external source, for example a solar collector, but not limited thereto.

Beneficially, the array 10A, 10B and the array arrangement apparatus 500 may be disposed in large array facilities, for example in solar arrays, for generating large amounts of electrical energy. Alternatively, the array 10A, 10B and the array arrangement apparatus 500 may be implemented in miniaturized form and included in portable electronic apparatus, for example portable computers, smartphones, drones, satellites, space probes and such like.

Referring next to FIG. 4, there are shown steps of a method for (namely, a method of) operating the array 10A, 10B and, mutatis mutandis, the array arrangement apparatus 500; a flowchart of the method is indicated generally by 600. The method 600 for operating the optical waveguide array 10A, 10B and the optical waveguide array apparatus 500 includes steps 610 to 640.

The step 610 includes arranging for the at least one waveguide structure, for example including the waveguides 40, 50A, 50B, 60, to be fabricated at least in part from a material that exhibits one or more non-linear optical effects when in use.

The step 620 includes configuring an electrode arrangement, for example including the electrodes 90, 120, to control the one or more non-linear optical effects and to extract at least one of accelerated electrons and positrons from the at least one waveguide structure.

The step 630 includes configuring the optical waveguide array 10A, 10B or the optical waveguide array apparatus 500, when in use, to separate photons input on the at least one waveguide structure using the one or more non-linear optical effects into their respective electrons and positrons.

The step 640 includes guiding the respective electrons and positrons into their respective regions of the at least one waveguide structure to cause a matter-antimatter dipole to be formed within the at least one waveguide structure waveguide structure for imparting energy to at least one of the electrons and the positrons to cause acceleration thereof.

The method 600 includes configuring the array 10A, 10B or the apparatus 500 to output electrical energy in response to supplying the photons to the array 10A, 10B or the apparatus 500. In such a manner of operation the array 10A, 10B or the apparatus 500 functions as an energy converter or even as a form of energy amplifier, namely consistent with known laws of physics, for example as aforementioned. Alternative or additionally, in such a manner of operation the array 10A, 10B or the apparatus 500 functions as a positron generator, for example for providing a positron beam for use in positron tomography, research or similar.

Beneficially, the aforesaid one or more non-linear optical effects includes an optical Kerr effect. The optical Kerr effect results in a refractive index change that causes in the substrate electrons to group with other electrons, and likewise positrons to group with other positrons, resulting in an enhanced positron-electron dipole, and thereby acceleration experienced by the electrons and the positrons in the substrate 20 and its associated structures.

It is to be understood that arrangements of components illustrated in the aforesaid diagrams and described above are exemplary and that other arrangements may be possible within the scope of the claims as appended herewith. Although the disclosure and its advantages have been described in detail, it is to be understood that various changes, substitutions, and alterations may be made herein without departing from the spirit and scope of the disclosure as defined by the appended claims.

### STATEMENTS

Statement 1: An optical waveguide array device (10A; 10B; 500) including a substrate (20), and at least one waveguide structure (40, 50A, 50B, 60) formed onto the substrate (20), wherein the at least one waveguide structure (40, 50A, 50B, 60) is fabricated at least in part from a material that exhibits one or more non-linear optical effects when in use, and an electrode arrangement (90, 120) configured to control the one or more non-linear optical effects and to extract at least one of accelerated electrons and positrons from the at least one waveguide structure (40, 50A, 50B, 60), and wherein the optical waveguide array device (10A; 10B; 500) is configured in use to separate photons input to the at least one waveguide structure (40, 50A, 50B, 60) using the one or more non-linear optical effects into their respective electrons and positrons, and to guide the respective electrons and positrons into their respective regions of the at least one waveguide structure (40, 50A, 50B, 60) to cause a matter-antimatter dipole to be formed within the at least one waveguide structure waveguide structure (40, 50A, 50B, 60) for imparting energy to at least one of the electrons and the positrons to cause acceleration thereof.
Statement 2: An optical waveguide array device (10A; 10B; 500) of Statement 1, wherein the one or more non-linear optical effects includes an optical Kerr effect, wherein the optical Kerr effect results in a refractive index change that causes the substrate electrons to group with other electrons, and likewise substrate positrons to group with other positrons, resulting in an enhanced positron-electron dipole, and thereby enhanced acceleration experienced by the electrons and the positrons in the optical waveguide array device (10A; 10B; 500).
Statement 3: An optical waveguide array device (10A; 10B; 500) of Statement 1 or 2, wherein the substrate (20) is fabricated from a dielectric material, and the material of the at least one waveguide structure (40, 50A, 50B, 60) includes at least one of: Lithium Niobate (LiNiO₃), Barium Niobate (BaNiO₃), Graphene, doped Graphene.
Statement 4: An optical waveguide array device (10A; 10B; 500) of Statement 1, 2 or 3, wherein the substrate (20) is fabricated from a dielectric material, wherein the dielectric material optionally includes at least one of: quartz, fused silica.
Statement 5: An optical waveguide array device (10A; 10B; 500) of Statement 1, 2, 3 or 4, wherein the electrode arrangement (90, 120) comprises a configuration of electrodes (90, 120) whose elongate axes are configured to be substantially parallel to, or substantially orthogonal to, elongate axes of a plurality elongate waveguides (50A, 50B) into which the corresponding electrons and positrons are selectively diverted when the device (10A; 10B; 500) is in operation.
Statement 6: An optical waveguide array device (10A; 10B; 500) of Statement 5, wherein the electrode arrangement (90, 120) is fabricated from at least one of: Titanium, Aluminium, Indium, Silver.
Statement 7: An optical waveguide array device (10A; 10B; 500) of any one of the preceding Statements, wherein the device (10A; 10B; 500) includes a plurality of the at least one waveguide structure (40, 50A, 50B, 60) arranged in a cascaded configuration.
Statement 8: An optical waveguide array device (10A; 10B; 500) of any one of the preceding Statements, wherein the device (10A; 10B; 500) further includes a laser arrangement (70) configured in use to provide photons to the at least one waveguide structure (40, 50A, 50B, 60).
Statement 9: An optical waveguide array device (10A; 10B; 500) of Statement 8, wherein the laser arrangement (70) is configured to function in at least one of: a continuous mode, a pulsed mode, a combination of continuous and pulsed modes.
Statement 10: An optical waveguide array device (10A; 10B; 500) of any one of the preceding Statements, wherein waveguides of the at least one waveguide structure (40, 50A, 50B, 60) are disposed in a parallel mutually spaced-apart manner with a distance (d) therebetween, wherein the distance is substantially of a similar size to a wavelength of the photons supplied to the at least one waveguide structure (40, 50A, 50B, 60) when in operation.
Statement 11: An optical waveguide array device (10A; 10B; 500) of Statement 10, wherein the distance (d) is configured to allow for photon coherence to be maintained between mutually adjacent elongate waveguides (50A, 50B) of the at least one waveguide structure (40, 50A, 50B, 60).
Statement 12: A method (600) for operating an optical waveguide array device (10A; 10B; 500) including a substrate (20), and at least one waveguide structure (40, 50A, 50B, 60) formed onto the substrate (20), wherein the method (600) includes:
   (i) arranging for the at least one waveguide structure (40, 50A, 50B, 60) to be fabricated at least in part from a material that exhibits one or more non-linear optical effects when in use;
   (ii) configuring an electrode arrangement (90, 120) to control the one or more non-linear optical effects and to extract at least one of accelerated electrons and positrons from the at least one waveguide structure (40, 50A, 50B, 60);
   (iii) configuring the optical waveguide array device (10A; 10B; 500), when in use, to separate photons input on the at least one waveguide structure (40, 50A, 50B, 60) using the one or more non-linear optical effects into their respective electrons and positrons; and
   (iv) guiding the respective electrons and positrons into their respective regions of the at least one waveguide structure (40, 50A, 50B, 60) to cause a matter-antimatter dipole to be formed within the at least one waveguide structure waveguide structure (40, 50A, 50B, 60) for imparting energy to at least one of the electrons and the positrons to cause acceleration thereof.
Statement 13: A method (600) of Statement 12, wherein the one or more non-linear optical effects includes an optical Kerr effect, wherein the optical Kerr effect results in a refractive index change that causes the substrate electrons to group with other electrons, and likewise substrate positrons to group with other positrons, resulting in an enhanced positron-electron dipole, and thereby enhanced acceleration experienced by the electrons and the positrons in the optical waveguide array device (10A; 10B; 500).
Statement 14: A method (600) of Statement 12 or 13, wherein the method (600) includes fabricating the substrate (20) from a dielectric material, and arranging for the material of the at least one waveguide structure (40, 50A, 50B, 60) to include at least one of: Lithium Niobate (LiNiO₃), Barium Niobate (BaNiO₃), Graphene, doped Graphene.
Statement 15: A method (600) of Statement 12, 13 or 14, wherein the method (600) includes fabricating the substrate (20) from a dielectric material, wherein the dielectric material optionally includes at least one of: quartz, fused silica.
Statement 16: A method (600) of Statement 12, 13, 14 or 15, wherein the electrode arrangement (90, 120) comprises a configuration of electrodes whose elongate axes are configured to be substantially parallel to, or substantially orthogonal to, elongate axes of a plurality elongate waveguides (50A, 50B) into which the corresponding electrons and positrons are selectively diverted when the device (10A; 10B; 500) is in operation.
Statement 17: A method (600) of Statement 16, wherein the electrode arrangement (90, 120) is fabricated from at least one of: Titanium, Aluminium, Indium, Silver.
Statement 18: A method (600) of any one of the preceding Statements 12 to 17, wherein the method (600) includes arranging for the device (10A; 10B; 500) to include a plurality of the at least one waveguide structure (40, 50A, 50B, 60) arranged in a cascaded configuration.
Statement 19: A method (600) of any one of the preceding Statements 12 to 18, wherein the method (600) further includes arranging for the device (10A; 10B; 500) to further include a laser arrangement (70) configured in use to provide photons to the at least one waveguide structure (40, 50A, 50B, 60).
Statement 20: A method (600) of Statement 19, wherein the method (600) includes configuring the laser arrangement (70) to function in at least one of: a continuous mode, a pulsed mode, a combination of continuous and pulsed modes.
Statement 21: A method (600) of any one of the preceding Statements 12 to 20, wherein the method (600) includes arranging for waveguides of the at least one waveguide structure (40, 50A, 50B, 60) to be disposed in a parallel mutually-spaced-apart manner with a distance (d) therebetween, wherein the distance is substantially of a similar size to a wavelength of the photons supplied to the at least one waveguide structure (40, 50A, 50B, 60) when in operation.
Statement 22: A method (600) of Statement 21, wherein the method (600) includes configuring the distance (d) to allow for photon coherence to be maintained between mutually adjacent elongate waveguides (50A, 50B) of the at least one waveguide structure (40, 50A, 50B, 60).
Statement 23: A software product recorded on a machine-readable data carrier, wherein the software product is executable on computing hardware (520) of the device (10; 500) of any one of Statements 1 to 11, to implement a method of any one of Statements 12 to 22.

We claim:

1. An optical waveguide array device including a substrate, and at least one waveguide structure formed onto the substrate, wherein the at least one waveguide structure is fabricated at least in part from a material that exhibits one or more non-linear optical effects when in use, and an electrode arrangement configured to control the one or more non-linear optical effects and to extract at least one of accelerated electrons and positrons from the at least one waveguide structure, and wherein the optical waveguide array device is configured in use to separate photons input to the at least one waveguide structure using the one or more non-linear optical effects into their respective electrons and positrons, and to guide the respective electrons and positrons into their respective regions of the at least one waveguide structure to cause a matter-antimatter dipole to be formed within the at least one waveguide structure waveguide structure for imparting energy to at least one of the electrons and the positrons to cause acceleration thereof.

2. The optical waveguide array device of claim 1, wherein the one or more non-linear optical effects includes an optical Kerr effect, wherein the optical Kerr effect results in a refractive index change that causes the substrate electrons to group with other electrons, and likewise substrate positrons to group with other positrons, resulting in an enhanced positron-electron dipole, and thereby enhanced acceleration experienced by the electrons and the positrons in the optical waveguide array device.

3. The optical waveguide array device of claim 1, wherein the substrate is fabricated from a dielectric material, and the material of the at least one waveguide structure includes at least one of: Lithium Niobate (LiNiO₃), Barium Niobate (BaNiO₃), Graphene, doped Graphene.

4. The optical waveguide array device of claim 1, wherein the substrate is fabricated from a dielectric material, wherein the dielectric material optionally includes at least one of: quartz, fused silica.

5. The optical waveguide array device of claim 1, wherein the electrode arrangement comprises a configuration of electrodes whose elongate axes are configured to be substantially parallel to, or substantially orthogonal to, elongate axes of a plurality elongate waveguides into which the corresponding electrons and positrons are selectively diverted when the device is in operation, optionally wherein the electrode arrangement is fabricated from at least one of: Titanium, Aluminium, Indium, Silver.

6. The optical waveguide array device of claim 1, wherein the optical waveguide array device includes a plurality of the at least one waveguide structure arranged in a cascaded configuration.

7. The optical waveguide array device of claim 1, wherein the optical waveguide array device further includes a laser arrangement configured in use to provide photons to the at least one waveguide structure, optionally wherein the laser arrangement is configured to function in at least one of: a continuous mode, a pulsed mode, a combination of continuous and pulsed modes.

6. The optical waveguide array device of claim 1, wherein the waveguides of the at least one waveguide structure are disposed in a parallel mutually spaced-apart manner with a distance (d) therebetween, wherein the distance is substantially of a similar size to a wavelength of the photons supplied to the at least one waveguide structure when in operation, optionally wherein the distance (d) is configured to allow for photon coherence to be maintained between mutually adjacent elongate waveguides of the at least one waveguide structure.

9. A method for operating an optical waveguide array device including a substrate, and at least one waveguide structure formed onto the substrate, wherein the method includes:
(i) arranging for the at least one waveguide structure to be fabricated at least in part from a material that exhibits one or more non-linear optical effects when in use;
(ii) configuring an electrode arrangement to control the one or more non-linear optical effects and to extract at least one of accelerated electrons and positrons from the at least one waveguide structure;
(iii) configuring the optical waveguide array device, when in use, to separate photons input on the at least one waveguide structure using the one or more non-linear optical effects into their respective electrons and positrons; and
(iv) guiding the respective electrons and positrons into their respective regions of the at least one waveguide structure to cause a matter-antimatter dipole to be formed within the at least one waveguide structure waveguide structure for imparting energy to at least one of the electrons and the positrons to cause acceleration thereof.

10. The method of claim 9, wherein the one or more non-linear optical effects includes an optical Kerr effect, wherein the optical Kerr effect results in a refractive index change that causes the substrate electrons to group with other electrons, and likewise substrate positrons to group with other positrons, resulting in an enhanced positron-electron dipole, and thereby enhanced acceleration experienced by the electrons and the positrons in the optical waveguide array device.

11. The method of claim 9, wherein the method includes fabricating the substrate from a dielectric material, and arranging for the material of the at least one waveguide structure to include at least one of: Lithium Niobate (LiNiO₃), Barium Niobate (BaNiO₃), Graphene, doped Graphene.

12. The method of claim 9, wherein the method includes fabricating the substrate from a dielectric material, wherein the dielectric material optionally includes at least one of: quartz, fused silica.

13. The method of claim 9, wherein the electrode arrangement comprises a configuration of electrodes whose elongate axes are configured to be substantially parallel to, or substantially orthogonal to, elongate axes of a plurality elongate waveguides into which the corresponding electrons and positrons are selectively diverted when the device is in operation; optionally wherein the electrode arrangement is fabricated from at least one of: Titanium, Aluminium, Indium, Silver.

14. The method of claim 9, wherein the method includes arranging for the device to include a plurality of the at least one waveguide structure arranged in a cascaded configuration.

15. The method of claim 9, wherein the method further includes arranging for the device to further include a laser arrangement configured in use to provide photons to the at least one waveguide structure, optionally wherein the method includes configuring the laser arrangement to function in at least one of: a continuous mode, a pulsed mode, a combination of continuous and pulsed modes.

16. The method of claim 9, wherein the method includes arranging for waveguides of the at least one waveguide structure to be disposed in a parallel mutually-spaced-apart manner with a distance (d) therebetween, wherein the distance is substantially of a similar size to a wavelength of the photons supplied to the at least one waveguide structure when in operation, optionally wherein the method includes configuring the distance (d) to allow for photon coherence to be maintained between mutually adjacent elongate waveguides of the at least one waveguide structure.

17. A software product recorded on a non-transitory machine-readable data carrier, wherein the software product is executable on a computing hardware to implement the method as claimed in claim 9.
